(19) United States
(12) Patent Application Publication
(10) Pub. No.: US 2025/0260340 A1
(43) Pub. Date: Aug. 14, 2025

(54) Multi-Source Inverter and Modulation Schemes Therefor

(71) Applicant: Queen's University at Kingston, Kingston (CA)

(72) Inventors: Javad Ebrahimi Jouzdani, Kingston (CA); Suzan Eren, Kingston (CA)

(21) Appl. No.: 19/045,961

(22) Filed: Feb. 5, 2025

Related U.S. Application Data
(60) Provisional application No. 63/551,337, filed on Feb. 8, 2024.

(51) Int. Cl. H02M 7/539; B60L 15/00

(52) U.S. Cl. CPC H02M 7/539; B60L 15/007

(57) ABSTRACT

A multi-source inverter (MSI) topology features significant advantages over conventional MSI converters such as NPC-based and T-Type-based topologies, including a lower number of switching devices, higher efficiency, and better thermal distribution of switching devices. A space vector modulation (SVM) scheme for MSI topologies presented herein and for conventional MSI topologies uses three or four adjacent vectors to generate a reference voltage vector, resulting in lower voltage and current total harmonic distortion (THD) at the MSI output, a lower switching frequency, and increased efficiency relative to conventional MSI modulation. Embodiments are suitable for use in electric vehicles and energy storage systems.

### RELATED APPLICATION

This application claims the benefit of the filing date of Application No. 63/551,337, filed on Feb. 8, 2024, the contents of which are incorporated herein by reference in their entirety.

### FIELD

The invention relates to topologies and modulation schemes that improve performance and reduce size and cost of multi-source inverters.

### BACKGROUND

A multi-source inverter (MSI) is a power converter that connects distinct DC sources to the same AC output using a single conversion stage. The use of multi-source inverters as a new generation of traction inverters in electric vehicles has been proposed [2]-[3]. In an electric vehicle (EV), a multi-source inverter allows independent DC sources to drive the propulsion motor while simultaneously using the battery voltage as one DC voltage link. This topology can be applied to hybrid electric vehicle (HEV) and plug-in hybrid electric vehicle (PHEV) powertrains, where the input is directly connected to the battery pack and the DC-link voltage is shared between both inverters, as shown in FIG. 1 [3]. This enables the battery pack to transfer power directly to the traction motor without requiring a DC/DC converter to step up the voltage. In addition, the high-power DC/DC converter can be dissociated from the traction mode and only used for starting the internal combustion engine (ICE) and for regenerative braking. Further, unlike conventional hybrid powertrains, the battery and the DC/DC converter are connected in parallel. As a result, the DC/DC converter can be bypassed in traction mode. This allows its power rating to be reduced from tens of kW to a few kW without degrading the battery system. Having only a single conversion stage between the battery and motor also improves the overall efficiency of an electrified traction drive.

A combination of input voltage sources can be applied to the load using a multi-source inverter. In this regard, different DC storage devices can feed the same AC load through a single-stage magnetic-less DC/AC power conversion. These structures improve the overall volume, weight, and efficiency of the system due to the elimination of the magnetics from the circuit. Moreover, MSI circuits introduce a high degree of freedom for the selection and integration of storage devices with complementary characteristics to satisfy the load requirements based on the load features. From the voltage source inverter point of view, the DC link voltage of an MSI is not fixed. In other words, a combination of input voltage sources can be applied to the load as the load reference voltage or current changes. This way, improved efficiency performance can be achieved for the hybrid energy storage system (HESS). Moreover, in EV applications, the efficiency of the electric motor is compromised at low speeds where the value of the modulation index is very small. However, in an MSI topology, this voltage is not fixed. Thus, a combination of different voltage amplitudes can be applied to the electric motor based on the value of the reference speed, which improves the performance of the electric motor in comparison with traditional systems.

FIG. 2 shows the prior topology with two DC inputs V_{DC1} and V_{DC2} connected between (O) and (P₁) and (O) and (P₂). When the multi-source inverter is applied to hybrid powertrains, the DC-link voltage V_{DC1} is shared with the other inverter while V_{DC2} is supplied by a battery pack. By replacing the ideal switches in FIG. 2 with insulated gate bipolar transistors (IGBTs), two circuits can be used to realize the multi-source inverter and are very similar to three-level inverters, namely the neutral point clamped (NPC) and T-NPC topologies (see FIG. 3).

The MSI has been studied for use in the powertrain of certain hybrid vehicles for the purpose of reducing the power rating of the DC/DC converter between the storage systems and the high voltage DC link. The same topology is used in [3] for active control of the battery/super capacitor combination. This topology is based on the neutral point clamped three-level inverter structure. A study of the functionality of the same topology as an AC/DC rectifier in the regenerative braking mode for EV applications has been reported in [3]. Despite the positive operational benefits of this topology, practical issues of the neutral point clamped converter, including the need for high-power switching devices, loss balancing, and thermal cycling of the switching devices limit its application in EVs.

### SUMMARY

According to one aspect of the invention there is provided a modulation scheme for a three-phase multi-source inverter (MSI), comprising: defining a stationary αβ plan of the three-phase voltages comprising six sectors I to VI, wherein each sector has seven existing space voltage vectors; defining V_{ref} as a three-phase reference voltage vector in the αβ plan; for each sector, calculating new space voltage vectors V_{M}, V_{S}, and V_{R} as linear combinations of at least two of the existing space voltage vectors; dividing each sector into nine operating regions; generating switching signals for switching devices of the MSI in each operating region in each sector using the V_{ref}, selected new space voltage vectors, and selected existing space voltage vectors.

In one embodiment the generating switching signals comprises using four selected existing space voltage vectors.

In one embodiment the four selected existing space voltage vectors include V₃-V₆.

In one embodiment the modulation scheme comprises: calculating the new space voltage vectors for one sector selected from sectors I to VI; determining corresponding new space voltage vectors in other sectors by interchanging the new space voltage vectors determined for the selected sector.

According to another aspect of the invention there is provided a controller for a three-phase MSI, comprising: a processor; non-transitory computer readable media storing an algorithm that directs the processor to implement a space vector modulation (SVM) scheme for the MSI; an output circuit that outputs switching signals to switches of the MSI according to the SVM scheme; wherein the SVM scheme comprises: defining a stationary αβ plan of the three-phase voltages comprising six sectors I to VI, wherein each sector has seven existing space voltage vectors; defining V_{ref} as a three-phase reference voltage vector in the αβ plan; for each sector, calculating new space voltage vectors V_{M}, V_{S}, and V_{R} as linear combinations of at least two of the existing space voltage vectors; dividing each sector into nine operating regions; generating switching signals for switching devices of the MSI in each operating region in each sector using the V_{ref}, selected new space voltage vectors, and selected existing space voltage vectors.

The controller may be implemented in an electric vehicle.

According to another aspect of the invention there is provided a three-phase multi-source inverter (MSI), comprising: a first switch having an input terminal adapted to receive a positive side of a first DC source (V_{DC1}); a second switch having an input terminal adapted to receive a negative side of the first DC source (V_{DC1}) and a negative side of a second DC source (V_{DC2}); an output of the first switch connected to inputs of third, fifth, seventh, and ninth switches; the third switch having an output terminal adapted to receive a positive side of the second DC source (V_{DC2}) and connected to an input of a fourth switch; outputs of the fifth, seventh, and ninth switches connected to inputs of sixth, eighth, and tenth switches and to output nodes corresponding to respective MSI three-phase output currents iₐ, i_{b}, and i_{c}; outputs of the second, fourth, sixth, eighth, and tenth switches connected together.

One embodiment comprises at least one DC-DC converter that provides the first DC source or the second DC source.

In one embodiment the first DC source comprises a high voltage source and the second DC source comprises a low voltage source.

In one embodiment the first DC source comprises a high voltage source and the second DC source comprises a battery, a super capacitor, or an ultra capacitor.

In one embodiment the three-phase MSI may be configured for use in an electric vehicle.

In one embodiment the three-phase MSI may comprise a controller.

In one embodiment the controller controls switches of the MSI according to a space vector modulation (SVM) scheme.

In one embodiment the SVM scheme comprises: defining a stationary αβ plan of the three-phase voltages comprising six sectors I to VI, wherein each sector has seven existing space voltage vectors; defining V_{ref} as a three-phase reference voltage vector in the αβ plan; for each sector, calculating new space voltage vectors V_{M}, V_{S}, and V_{R} as linear combinations of at least two of the existing space voltage vectors; dividing each sector into nine operating regions; generating switching signals for switching devices of the MSI in each operating region in each sector using the V_{ref}, selected new space voltage vectors, and selected existing space voltage vectors.

In one embodiment the three-phase MSI may be configured for use in an electric vehicle.

According to another aspect of the invention there is provided a three-phase MSI comprising a controller, wherein the controller controls switches of the MSI according to a space vector modulation (SVM) scheme as described herein. In one embodiment the three-phase MSI comprising a controller may be configured for use in an electric vehicle.

According to another aspect of the invention there is provided a non-transitory computer readable media compatible with a processor, the non-transitory computer readable media storing an algorithm that directs the processor to implement a space vector modulation (SVM) scheme for an MSI; wherein the SVM scheme comprises: defining a stationary αβ plan of the three-phase voltages comprising six sectors I to VI, wherein each sector has seven existing space voltage vectors; defining V_{ref} as a three-phase reference voltage vector in the αβ plan; for each sector, calculating new space voltage vectors V_{M}, V_{S}, and V_{R} as linear combinations of at least two of the existing space voltage vectors; dividing each sector into nine operating regions; generating switching signals for switching devices of the MSI in each operating region in each sector using the V_{ref}, selected new space voltage vectors, and selected existing space voltage vectors.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a block diagram of a hybrid powertrain with a multi-source inverter suitable for use in a hybrid electric vehicle, according to the prior art.

FIG. 2 is a diagram of a multi-source inverter topology showing three operating modes, according to the prior art.

FIG. 3 is a schematic diagram of a multi-source inverter based on an NPC topology, according to the prior art.

FIG. 4 is a schematic diagram of a multi-source inverter, according to one embodiment.

FIG. 5 is a schematic diagram of a multi-source inverter, according to one embodiment.

FIG. 6 is a space vector plan of a multi-source inverter.

FIG. 7 is a voltage space vector diagram of sector I of a multi-source inverter.

FIG. 8 is a diagram defining new space vectors in sector I.

FIG. 9 is a diagram showing the regions in sector I.

FIGS. 10A-10C are plots of conduction loss, switching loss, and efficiency, respectively, of multi-source inverters according to an embodiment and according to the prior art, under a modulation scheme according to an embodiment and a conventional modulation scheme.

FIGS. 11A-11C are plots of experimental results of a multi-source inverter according to an embodiment operating in mode I, wherein (A) is line voltage, (B) is load currents, and (C) is DC currents (lower: DC source current, upper: UC current).

FIGS. 12A-12C are plots of experimental results of a multi-source inverter according to an embodiment for a transition from operating mode I to operating mode II, wherein (A) is line voltage, (B) is load currents, and (C) is DC currents (upper: DC source current, lower: UC current).

FIGS. 13A-13C are plots of experimental results of a multi-source inverter according to an embodiment operating in mode III, wherein (A) is line voltage, (B) is load currents, and (C) is DC currents (upper: DC source current, lower: UC current).

FIGS. 14A-14C are plots of experimental results of a multi-source inverter according to an embodiment for a load step change from full load to 20% of full load, wherein (A) is line voltage, (B) is load currents, and (C) is DC currents (upper: DC source current, lower: UC current).

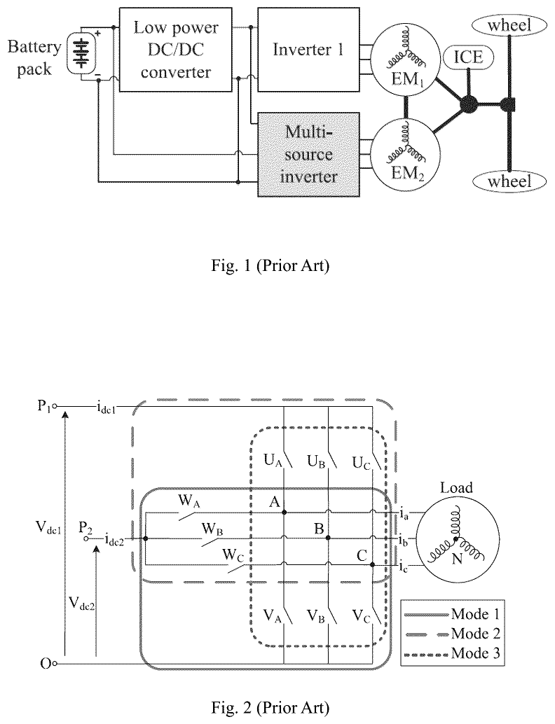

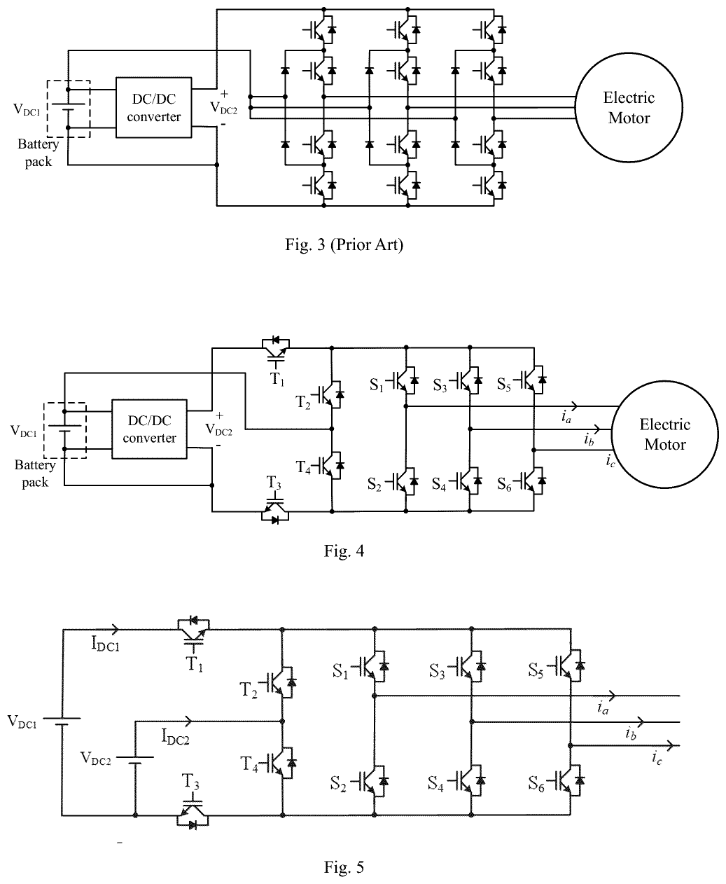

### DETAILED DESCRIPTION OF EMBODIMENTS

### MSI Topology

Described herein is a hybrid MSI topology that features significant advantages over conventional state-of-the-art converters such as NPC-based and T-Type-based topologies, including:
Lower number of switching devices,
Higher efficiency,
Simple hardware design and packaging,
Lower cost, volume, and weight,
Better thermal distribution of switching devices.

Embodiments are suitable for applications such as, but not limited to, an electric vehicle, examples of which may include a battery electric vehicle (BEV), hybrid electric vehicle (HEV), and plug-in hybrid electric vehicle (PHEV), all of which are referred to herein generally as an electric vehicle (EV), and other applications such as a hybrid energy storage system (HESS).

An embodiment will be described in detail with reference to the MSI topology shown in FIG. 4. Referring to FIG. 4, the embodiment includes inputs for first and second DC-link voltages, V_{DC1} and V_{DC2}. For example, V_{DC1} may be a battery and V_{DC22} may be the output of a DC-DC converter. Switching pairs (T₁, T₂), and (T₃, T₄) operate in a complementary manner to prevent short circuit of the input DC-links. Output currents iₐ, i_{b}, and i_{c}, respectively produced at the node between switches S₁, S₂, switches S₃, S₄, and switches S₅, S₆, are delivered to the electric motor. Table 1 indicates switching states of the MSI topology, according to one embodiment. In Table I the switching functions 0 and 1 indicate that the switch is turned off and turned on, respectively.

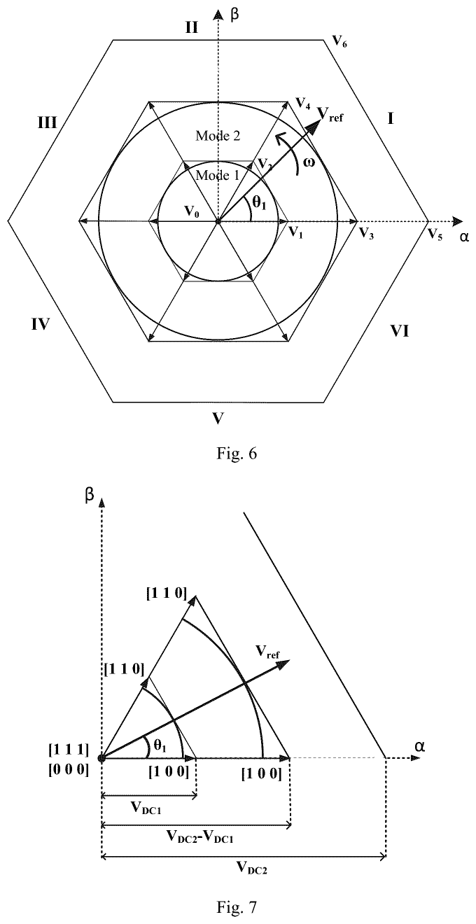

As shown in FIG. 5, in one embodiment the topology may be implemented as a multi-source converter utilizing a high-voltage DC source with the voltage rating of V_{DC1} and a second DC source having the voltage rating of V_{DC2} as the two DC-links. V_{DC2} may be, for example, a low-voltage battery pack or a super capacitor (SC) bank to handle the high number of charge/discharge modes in a typical driving cycle of an EV. In one embodiment the converter may be operated according to a modulation scheme to generate a voltage waveform with a peak-to-peak amplitude of DC link voltage with a desired fundamental frequency. In one embodiment there are three different values for discrete adjustable DC-link voltages, namely, V_{DC1}, V_{DC2}, and the subtraction of the two sources which is V_{DC1}-V_{DC2}.

By selecting different values of the discrete DC links, embodiments of the MSI may be operated in three DC/AC conversion modes where different combinations of the input DC sources may be connected to the load. For example:

1) Mode I: The load is supplied by the source V_{DC2} and the source V_{DC1} is not used. Due to the smaller amplitude of the source V_{DC2}, this mode is appropriate for light loads with small power/voltage requirements.

2) Mode II: The two DC sources are connected in differential series connection and the value of DC-link voltage is equal to V_{DC1}-V_{DC2}. With the positive current idc1, the source V_{DC1} supplies the load and simultaneously charges the source V_{DC2}. This mode may be used for cases where the state of charge (SOC) of the second DC source is less than a certain level or the load requires more power/voltage in comparison to Mode I.

3) Mode III: The load is supplied by the source V_{DC1} and the source V_{DC2} is not used. Since the voltage of the first DC link is essentially selected to be higher than V_{DC2} and V_{DC1}-V_{DC2}, this mode may be selected for loads that require higher power/voltage values than Mode 1 and Mode II.

TABLE 1
Switching States of MSI Topology in Various Operating Modes

| | States of | | | | | | | |
|---|---|---|---|---|---|---|---|---|
| | Switches | | | | | Line-to-Line Voltages | | |
| Mode | T₁ | T₃ | S₁ | S₂ | S₃ | V_{AB} | V_{BC} | V_{CA} |
| I | 0 | 1 | 1 | 1 | 1 | 0 | 0 | 0 |
| | | | 1 | 1 | 0 | 0 | V_{DC2} | −V_{DC2} |
| | | | 1 | 0 | 1 | V_{DC2} | −V_{DC2} | 0 |
| | | | 1 | 0 | 0 | V_{DC2} | 0 | −V_{DC2} |
| | | | 0 | 1 | 1 | −V_{DC2} | 0 | V_{DC2} |
| | | | 0 | 1 | 0 | −V_{DC2} | V_{DC2} | 0 |
| | | | 0 | 0 | 1 | 0 | −V_{DC2} | V_{DC2} |
| | | | 0 | 0 | 0 | 0 | 0 | 0 |
| II | 1 | 0 | 1 | 1 | 1 | 0 | 0 | 0 |
| | | | 1 | 1 | 0 | 0 | V_{DC1} − V_{DC2} | −V_{DC1} + V_{DC2} |
| | | | 1 | 0 | 1 | V_{DC1} − V_{DC2} | −V_{DC1} + V_{DC2} | 0 |
| | | | 1 | 0 | 0 | V_{DC1} − V_{DC2} | 0 | −V_{DC1} + V_{DC2} |
| | | | 0 | 1 | 1 | −V_{DC1} + V_{DC2} | 0 | V_{DC1} − V_{DC2} |
| | | | 0 | 1 | 0 | −V_{DC1} + V_{DC2} | V_{DC1} − V_{DC2} | 0 |
| | | | 0 | 0 | 1 | 0 | −V_{DC1} + V_{DC2} | V_{DC1} − V_{DC21} |
| | | | 0 | 0 | 0 | 0 | 0 | 0 |
| III | 1 | 1 | 1 | 1 | 1 | 0 | 0 | 0 |
| | | | 1 | 1 | 0 | 0 | V_{DC1} | −V_{DC1} |
| | | | 1 | 0 | 1 | V_{DC1} | −V_{DC1} | 0 |
| | | | 1 | 0 | 0 | V_{DC1} | 0 | −V_{DC1} |
| | | | 0 | 1 | 1 | −V_{DC1} | 0 | V_{DC1} |
| | | | 0 | 1 | 0 | −V_{DC1} | V_{DC1} | 0 |
| | | | 0 | 0 | 1 | 0 | −V_{DC1} | V_{DC1} |
| | | | 0 | 0 | 0 | 0 | 0 | 0 |

### MSI Modulation

High-frequency modulation schemes may be utilized for synthesis of desired reference voltages at the AC side of a voltage-source converter. Space vector modulation (SVM) is an enhanced PWM scheme that offers several degrees of freedom for reference voltage generation in three-phase voltage source converters. SVM provides better utilization of the DC-link voltage and reduces THD as well as switching losses.

Described herein is a SVM method for controlling switches of multisource inverters. Embodiments may use three or four adjacent vectors to generate a reference voltage vector, in contrast to conventional SVM approaches in multi-source inverters that synthesize the reference voltage vector from two active vectors and one zero vector. A comparison of a MSI voltage waveform resulting from a modulation strategy embodiment as described herein to that using a conventional SVM approach showed that the voltage waveform of the embodiment provides a multi-level waveform scheme which decreases voltage and current total harmonic distortion (THD) at the output of the MSI relative to the conventional approach. In addition, a modulation scheme as described herein results in a substantial reduction in switching frequency. As a result, MSI efficiency is significantly increased at different operating points.

Embodiments provide SVM schemes for multi-source inverters that generate appropriate switching signals at various operating modes to achieve the above-mentioned advantages. FIG. 6 shows the voltage vectors resulting from the switching states of three operating modes of the MSI. The set of balanced three-phase reference voltages in the abc frame are transformed into a two-dimensional complex frame by the following transformation.

$$[ \begin{matrix}{v}_{α} \\ {v}_{β}\end{matrix} ] = \frac{2}{3} \times [ \begin{matrix}1 & - 1 / 2 & - 1 / 2 \\ 0 & \sqrt{3} / 2 & - \sqrt{3} / 2\end{matrix} ] [ \begin{matrix}{v}_{A n} \\ {v}_{B n} \\ {v}_{C n}\end{matrix} ] \qquad ( 1 )$$

where vₐₙ, v_{bn}, and v_{cn} are the three-phase voltages in the abc frame, and v_{α} and v_{β} are the resultant voltages in the stationary αβ plan. Applying the transformation to the output phase voltages of operating modes results in a set of switching voltage vectors that establish a three-layer hexagon centered at the origin of the αβ plan. Each hexagon includes six non-zero space voltage vectors and two zero vectors. Therefore, there are 18 non-zero voltage vectors in the αβ plan and six zero voltage vectors located at the origin of the αβ plan. The αβ plan is split up to six symmetric sectors shown by I to VI in FIG. 6.

The sector I of the corresponding αβ plan is shown in FIG. 7, where the voltage vectors at each vertex are shown with [lₐ l_{b} l_{c}]. lₐ, l_{b}, and l_{c} represent the generated voltage level of the phases a, b, and c, respectively. The voltage levels 0 and 1 correspond to the output voltages 0 and V_{dc} relative to the negative DC-link of the VSI, respectively. As shown in FIG. 6, the reference voltage vector V_{ref} represents the three-phase reference voltages in the αβ plan. In a balanced three-phase system, V_{ref} has a constant magnitude of |V_{ref}| and rotates counterclockwise at an angular frequency of ω. The modulation index is defined as follows:

$$M = \frac{2 \vert {V}_{r e f} \vert}{\sqrt{3} {V}_{d c 1}} \qquad ( 2 )$$

$$\vert {V}_{ref} \vert = \sqrt{{v}_{α}^{2} + {v}_{β}^{2}} \qquad ( 3 )$$

[3]-[6] The operating modes can be determined based on the magnitude of V_{ref}. As can be seen in FIG. 6, the maximum magnitude of V_{ref} in each hexagon is equal to the radius of the biggest inscribed circle. The appropriate operating mode is determined based on the |V_{ref}| as follows:

$$\{ \begin{matrix}Mode I & \vert {V}_{r e f} \vert \leq \frac{\sqrt{3}}{2} {V}_{dc 2} \\ Mode II & \frac{\sqrt{3}}{2} {V}_{dc 2} < \vert {V}_{ref} \vert \leq \frac{\sqrt{3}}{2} ( {V}_{dc 1} - {V}_{dc 2} ) \\ Mode III & \frac{\sqrt{3}}{2} ( {V}_{d c 1} - {V}_{d c 2} ) < \vert {V}_{ref} \vert \leq \frac{\sqrt{3}}{2} {V}_{d c 1}\end{matrix} \qquad ( 4 )$$

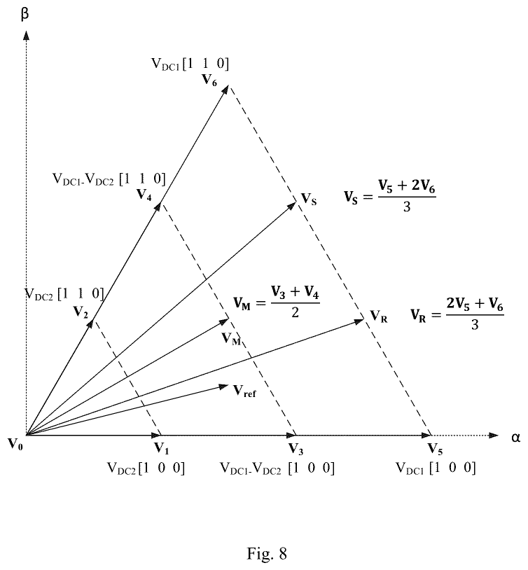

However, according to embodiments described herein, new space voltage vectors V_{M}, V_{S}, V_{R} are defined as linear combinations of selected existing space voltage vectors. For example, in one embodiment the selected existing space voltage vectors are V₃-V₆. According to this embodiment, as shown in FIG. 8 for the first sector, the new space voltage vectors are as follows:

$${V}_{M} = \frac{{V}_{3} + {V}_{4}}{2} \qquad ( 5 )$$

$${V}_{S} = \frac{{V}_{5} + 2 {V}_{6}}{2}$$

$${V}_{R} = \frac{2 {V}_{5} + {V}_{6}}{2}$$

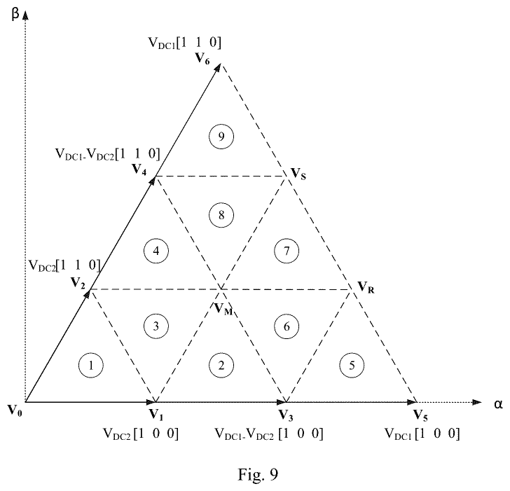

According to the new space voltage vectors defined above, the first sector is divided into nine regions as illustrated in FIG. 9. Every sampling period three adjacent voltage vectors are used to provide a voltage-second equivalent to V_{ref}. For the reference vector V_{ref} and the selected space voltage vectors (i.e., the three nearest adjacent space voltage vectors, e.g., for region 1 the three space voltage vectors are V₀, V₁, and V₂), the basic volt-second balance of the SVM scheme is implemented. Then, duty ratios of the new space voltage vectors are calculated. This may be repeated for each of the six sectors, although as described below steps may be implemented to reduce the number of calculations and thereby improve speed and efficiency of modulation implementations.

For example, the related equations and duty ratio determination for the nine different regions for one sector are as follows:

### Region 1:

$${V}_{ref} = {V}_{0} {D}_{0} + {V}_{1} {D}_{1} + {V}_{2} {D}_{2}$$

$${D}_{0} + {D}_{1} + {D}_{2} = 1$$

The duty ratios D₀, D₁, and D₂ are calculated using the above equations. Then, the duty ratios of three voltage vectors V₀, V₁, and V₂ are as follows:

$$\{ \begin{matrix}{D}_{{V}_{0}} = {D}_{0} \\ {D}_{{V}_{1}} = {D}_{1} \\ {D}_{{V}_{2}} = {D}_{2}\end{matrix}$$

### Region 2:

$${V}_{ref} = {V}_{1} {D}_{1} + {V}_{3} {D}_{3} + {V}_{M} {D}_{M}$$

$${D}_{1} + {D}_{3} + {D}_{M} = 1$$

The duty ratios D₁, D₃, and D_{M} are calculated using the above equations. Then, the duty ratios of three voltage vectors V₁, V₃, and V₄ are as follows:

$$\{ \begin{matrix}{D}_{{V}_{1}} = {D}_{1} \\ {D}_{{V}_{3}} = {D}_{3} + \frac{{D}_{M}}{2} \\ {D}_{{V}_{4}} = \frac{{D}_{M}}{2}\end{matrix}$$

### Region 3:

$$\begin{matrix}{V}_{ref} = {V}_{1} {D}_{1} + {V}_{M} {D}_{M} + {V}_{2} {D}_{2} \\ {D}_{1} + {D}_{M} + {D}_{2} = 1\end{matrix}$$

The duty ratios D₁, D_{M}, and D₂ are calculated using the above equations. Then, the duty ratios of four voltage vectors V₁, V₂, V₃, and V₄ are as follows:

$$\{ \begin{matrix}{D}_{{V}_{1}} = {D}_{1} \\ {D}_{{V}_{2}} = {D}_{2} \\ {D}_{{V}_{3}} = \frac{{D}_{M}}{2} \\ {D}_{{V}_{4}} = \frac{{D}_{M}}{2}\end{matrix}$$

### Region 4:

$$\begin{matrix}{V}_{ref} = {V}_{2} {D}_{2} + {V}_{M} {D}_{M} + {V}_{4} {D}_{4} \\ {D}_{2} + {D}_{M} + {D}_{4} = 1\end{matrix} \}$$

The duty ratios D₂, D_{M}, and D₄ are calculated using the above equations. Then, the duty ratios of three voltage vectors V₂, V₃, and V₄ are as follows:

$$\{ \begin{matrix}{D}_{{V}_{2}} = {D}_{2} \\ {D}_{{V}_{3}} = \frac{{D}_{M}}{2} \\ {D}_{{V}_{4}} = {D}_{4} + \frac{{D}_{M}}{2}\end{matrix}$$

### Region 5:

$$\begin{matrix}{V}_{ref} = {V}_{2} {D}_{2} + {V}_{M} {D}_{M} + {V}_{4} {D}_{4} \\ {D}_{2} + {D}_{M} + {D}_{4} = 1\end{matrix} \}$$

The duty ratios D₂, D_{M}, and D₄ are calculated using the above equations. Then, the duty ratios of three voltage vectors V₂, V₃, and V₄ are as follows:

$$\{ \begin{matrix}{D}_{{V}_{3}} = {D}_{3} \\ {D}_{{V}_{5}} = {D}_{5} + \frac{2}{3} {D}_{R} \\ {D}_{{V}_{6}} = \frac{{D}_{R}}{3}\end{matrix}$$

### Region 6:

$$\begin{matrix}{V}_{ref} = {V}_{3} {D}_{3} + {V}_{M} {D}_{M} + {V}_{R} {D}_{R} \\ {D}_{3} + {D}_{M} + {D}_{R} = 1\end{matrix} \}$$

The duty ratios D₃, D_{M}, and D_{R} are calculated using the above equations. Then, the duty ratios of four voltage vectors V₃, V₄, V₅ and V₆ are as follows:

$$\{ \begin{matrix}{D}_{{V}_{3}} = {D}_{3} + \frac{{D}_{M}}{2} \\ {D}_{{V}_{4}} = \frac{{D}_{M}}{2} \\ {D}_{{V}_{5}} = \frac{2}{3} {D}_{R} \\ {D}_{{V}_{6}} = \frac{{D}_{R}}{3}\end{matrix}$$

### Region 7:

$$\begin{matrix}{V}_{ref} = {V}_{R} {D}_{R} + {V}_{M} {D}_{M} + {V}_{S} {D}_{S} \\ {D}_{R} + {D}_{M} + {D}_{S} = 1\end{matrix} \}$$

The duty ratios D_{R}, D_{M}, and D_{S} are calculated using the above equations. Then, the duty ratios of three voltage vectors V₃, V₄, V₅ and V₆ are as follows:

$$\{ \begin{matrix}{D}_{{V}_{3}} = \frac{{D}_{M}}{2} \\ {D}_{{V}_{4}} = \frac{{D}_{M}}{2} \\ {D}_{{V}_{5}} = \frac{2}{3} {D}_{R} + \frac{1}{3} {D}_{S} \\ {D}_{{V}_{6}} = \frac{1}{3} {D}_{R} + \frac{2}{3} {D}_{S}\end{matrix}$$

### Region 8:

$$\begin{matrix}{V}_{ref} = {V}_{2} {D}_{2} + {V}_{M} {D}_{M} + {V}_{4} {D}_{4} \\ {D}_{2} + {D}_{M} + {D}_{4} = 1\end{matrix} \}$$

The duty ratios D₂, D_{M}, and D₄ are calculated using the above equations. Then, the duty ratios of three voltage vectors V₃, V₄, V₅ and V₆ are as follows:

$$\{ \begin{matrix}{D}_{{V}_{3}} = \frac{{D}_{M}}{2} \\ {D}_{{V}_{4}} = {D}_{4} + \frac{{D}_{M}}{2} \\ {D}_{{V}_{5}} = \frac{1}{3} {D}_{S} \\ {D}_{{V}_{6}} = \frac{2}{3} {D}_{S}\end{matrix}$$

### Region 9:

$$\begin{matrix}{V}_{ref} = {V}_{4} {D}_{4} + {V}_{S} {D}_{S} + {V}_{6} {D}_{6} \\ {D}_{4} + {D}_{S} + {D}_{6} = 1\end{matrix} \}$$

The duty ratios D₂, D_{M}, and D₄ are calculated using the above equations. Then, the duty ratios of three voltage vectors V₄, V₅ and V₆ are as follows:

$$\{ \begin{matrix}{D}_{{V}_{4}} = {D}_{4} \\ {D}_{{V}_{5}} = \frac{1}{3} {D}_{S} \\ {D}_{{V}_{6}} = {D}_{6} + \frac{2}{3} {D}_{S}\end{matrix}$$

The adjacent three space voltage vectors in sector I are the coordinates of the vertices of the triangle in which the tip of V_{ref} is located (FIG. 9). Based on the above equations for regions 1-9 in sector I, duty ratios of adjacent space voltage vectors may be determined.

The same procedure may be applied when the tip of the reference voltage vector V_{ref} is located in another sector. However, due to symmetry, the corresponding space voltage vectors in other sectors may be determined by interchanging the space voltage vectors determined in sector I. The corresponding duty ratios are the same as determined by the above equations for each region in sector I. This allows for a reduction in the number of calculations performed and improved efficiency of the controller.

### MSI Modulation Implementation

Embodiments may be implemented in a controller with power switching device gate drivers and logic circuitry in whole or in part using discrete (e.g., analogue) components and/or using digital technology. Embodiments may include integrated circuit (IC) implementation, which greatly reduces component cost and design complexity. Examples of suitable digital technologies include processors such as, but not limited to, digital signal processor (DSP), field programmable gate array (FPGA), application specific integrated circuit (ASIC), and microcontroller unit (MCU). For example, one or more components of a controller may be implemented using a suitable computer or hardware language (i.e., code) such as, for example, very high speed integrated circuit (VHSIC) hardware descriptive language (VHDL), register transfer language (RTL), or Verilog. Such an algorithm may be stored in a memory device and implemented in, for example, a DSP, FPGA, ASIC, or MCU device of a controller.

A controller may include components such as current sensor, voltage sensor, comparator, reference current generator, reference voltage generator, proportional-integral (PI) control, PWM, gate driver/buffer, nonvolatile memory device, etc.

Another aspect of the invention relates to non-transitory computer readable media for use with a processor, the computer readable media having stored thereon instructions that, when executed by the processor of a controller for a MSI, cause the controller to perform a modulation method according to embodiments described herein.

The invention is further described by way of the following non-limiting Examples.

### Example 1. Comparison of Topology with Prior Topologies

An embodiment based on FIG. 4 was compared to the prior NPC-based MSI topology [3] and the prior T-type based MSI topology (T-MSI) [4]. For the comparison, parameters that have a direct influence on the size, cost, and performance of the converters were taken into consideration.

Table 2 presents a comparison of features of the three different topologies. It can be seen from Table 2 that the number of DC links and operating modes is the same for each topology, however, the embodiment requires fewer switches, no diodes, and has good loss balancing of the switches compared to the prior approaches.

TABLE 2
Comparison of Prior Art MSI Topologies and MSI Embodiment

| | NPC MSI | T-MSI | MSI |
|---|---|---|---|
| Feature | [3] | [4] | Embodiment |
| Number of input DC links | 2 | 2 | 2 |
| Number of operating modes | 3 | 3 | 3 |
| Number of HF switches | 12 | 12 | 6 |
| Number of LF switches | 0 | 0 | 4 |
| Total number of switches | 12 | 12 | 10 |
| Number of diodes | 6 | 0 | 0 |
| Loss balancing of | Weak | Weak | Good |
| switching devices | | | |

### Example 2. Comparison of Switching Frequency and Output Voltage THD

An embodiment based on FIG. 4 was compared to the prior NPC-based MSI topology [3] under both conventional SVM and SVM according to an embodiment.

Measurements and calculations were carried out using the PSIM™ software simulation package (Altair Engineering Inc., Troy, MI, USA). The IGBT switch was IXYS IXGH40N60C2 (Littelfuse, Chicago, IL, USA) with current and voltage rating of 40 A and 600 V. The voltage amplitude of DC source 1, V_{DC1}, was considered to be three times of the voltage amplitude of DC source 2, V_{DC2}. Therefore, the MSIs have modulation indexes in the intervals [0 0.333], [0.333 0.666], and [0.666 1] when operating at mode 1, 2, and 3, respectively.

Results are presented in Table 3A (NPC-based MSI topology) and Table 3B (topology according to an embodiment) wherein it can be seen that the SVM scheme according to the embodiment enabled reduced switching frequencies and lower THD in the NPC-based topology, and the topology embodiment demonstrated improvements over the NPC-based topology under both modulation schemes.

TABLE 3A
Switching Frequency and Output Voltage THD of NPC-based MSI.

| | | | | | Output voltage | | |
|---|---|---|---|---|---|---|---|
| | | Switching frequency (kHz) | | | THD | | |
| | | f_{Sx1}, f_{Sx2}, f_{Sx3}, f_{Sx4} | | | (%) | | |
| | | (x = a, b, c) | | | Mode | Mode | Mode |
| Topology | Modulation | Mode III | Mode II | Mode I | III | II | I |
| NPC-based | Conventional | 10, 10, 10, 10 | 10, 0, 10, 0 | 0, 10, 0, 10 | 51 | 51 | 51 |
| MSI | Embodiment | 3.3, 6.8, 3.3, | 6.8, 5.4, 6.8, | 0, 6.7, 0, 6.7 | 40 | 43 | 51 |
| | | 6.8 | 5.4 | | | | |

TABLE 3B
Switching Frequency and Output Voltage
THD of MSI according to one embodiment.

| | | | | | Output voltage | | |
|---|---|---|---|---|---|---|---|
| | | Switching frequency (kHz) | | | THD | | |
| | | f_{S1}, f_{S2} | | | (%) | | |
| | | f_{T1}, f_{T3} | | | Mode | Mode | Mode |
| Topology | Modulation | Mode III | Mode II | Mode I | III | II | I |
| Embodiment | Conventional | 10, 10 | 10, 10 | 10, 10 | 51 | 51 | 51 |
| | | 0, 0 | 0, 0 | 0, 0 | | | |
| | Embodiment | 3.3, 3.3 | 3.3, 3.3 | 6.7, 6.7 | 40 | 43 | 51 |
| | | 0, 10 | 10, 10 | 0, 0 | | | |

### Example 3. Comparison of Losses and Efficiency

Losses and efficiency of an embodiment based on FIG. 4 were compared to the prior NPC-based MSI topology [3] under both conventional SVM and SVM according to an embodiment as described above. The power losses associated with a static converter mainly consist of the filter losses, the switching losses, and the conduction losses of the switching devices. Since the filter losses for different converters are expected to be similar if the harmonic spectra of their output voltages are similar, they were not considered.

The power loss calculation of the switching devices was carried out using the PSIM™ software simulation package (Altair Engineering Inc., Troy, MI, USA). The IGBT switch was IXYS IXGH40N60C2 (Littelfuse, Chicago, IL, USA) with current and voltage rating of 40 A and 600V, respectively. The voltage amplitude of DC source 1, V_{DC1}, was considered to be three times of the voltage amplitude of DC source 2, V_{DC2}. Therefore, the MSIs have modulation indexes in the intervals [0 0.333], [0.333 0.666], and [0.666 1] when operating at mode 1, 2, and 3, respectively.

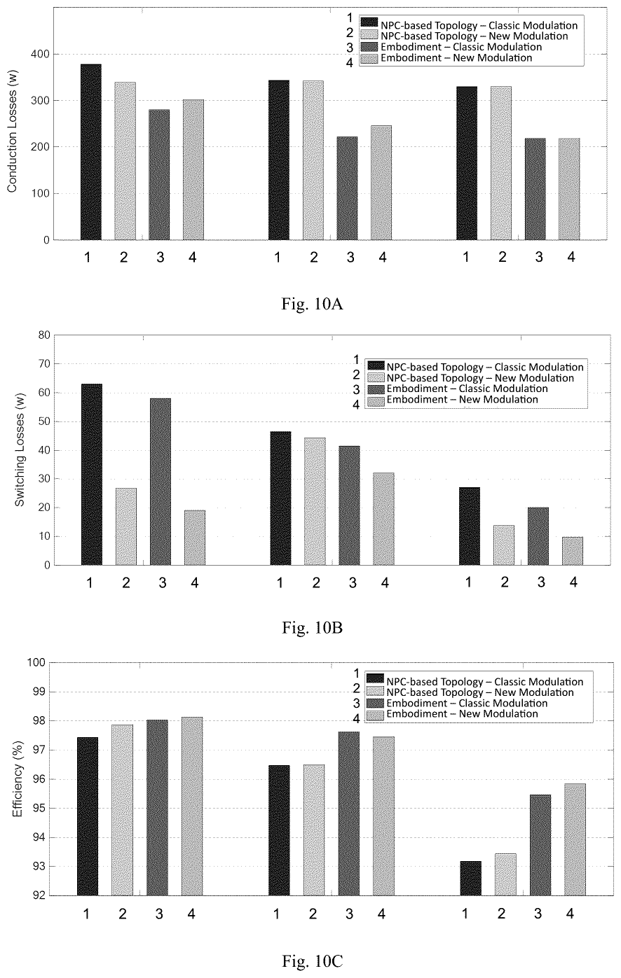

Results of the comparisons are shown in FIGS. 10A-10C, wherein it can be seen that conduction loss of the embodiment was less than that of the prior NPC-based topology under both modulation schemes (FIG. 10A) in all three operating modes. Switching loss of the embodiment MSI topology operating under the modulation scheme embodiment was lowest in all three operating modes (FIG. 10B). The calculated efficiency of the embodiment MSI topology was higher than the NPC-based topology under both modulation schemes in all three operating modes (FIG. 10C).

### Example 4. Prototype Testing

A scaled-down laboratory prototype was built and its performance evaluated. The prototype was modulated using a conventional space vector PWM (SVPWM) scheme with pulses generated using a digital signal processor (DSP). The experimental system parameters are given in Table 4. In the experimental setup, the first DC-link (V_{DC1}) was a DC source and the second DC-link (V_{DC2}) was an ultracapacitor (UC) implemented with a capacitor connected in parallel with a DC source.

TABLE 4
Experimental prototype system parameters.

| System Parameter | Value | |
|---|---|---|
| Switching devices | IGBT | |
| | Infineon IKW25N120H3 | |
| Gate driver optocouplers | Avago Technologies | |
| | ACPL-336J | |
| DC source voltage | 180 | V |
| UC voltage | 60 | V |
| UC capacitance | 10 | mF |
| Digital Signal Processor | Texas Instruments | |
| | TMS320F28335 | |
| Sampling frequency | 10 | kHz |
| Reference voltage frequency (fₒ) | 50 | Hz |

| | |
|---|---|
| Load-Resistive, Inductive (R, L) | 5 Ω, 9 mH |

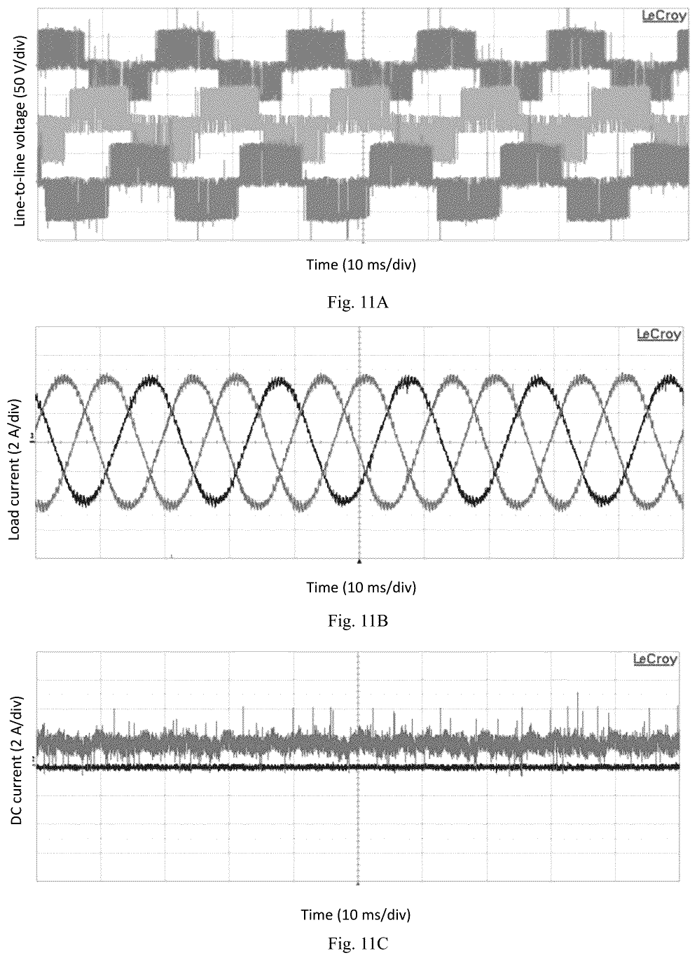

FIGS. 11A-11C show the experimental line-to-line voltages, three-phase load currents, and DC currents (FIG. 11C: lower, DC source current (V_{DC1}); upper, UC current (V_{DC2})) of the prototype operating under mode I. The load reference current was set to 2.5 A. The negative and positive peak values of the line-to-line voltage waveforms are associated with the DC voltage of the UC bank, which was 60 V. The three-phase sinusoidal load currents have amplitude near the reference current. As can be seen in FIG. 11C, the DC source current (lower trace) in mode I was zero and the load power was provided by the UC bank.

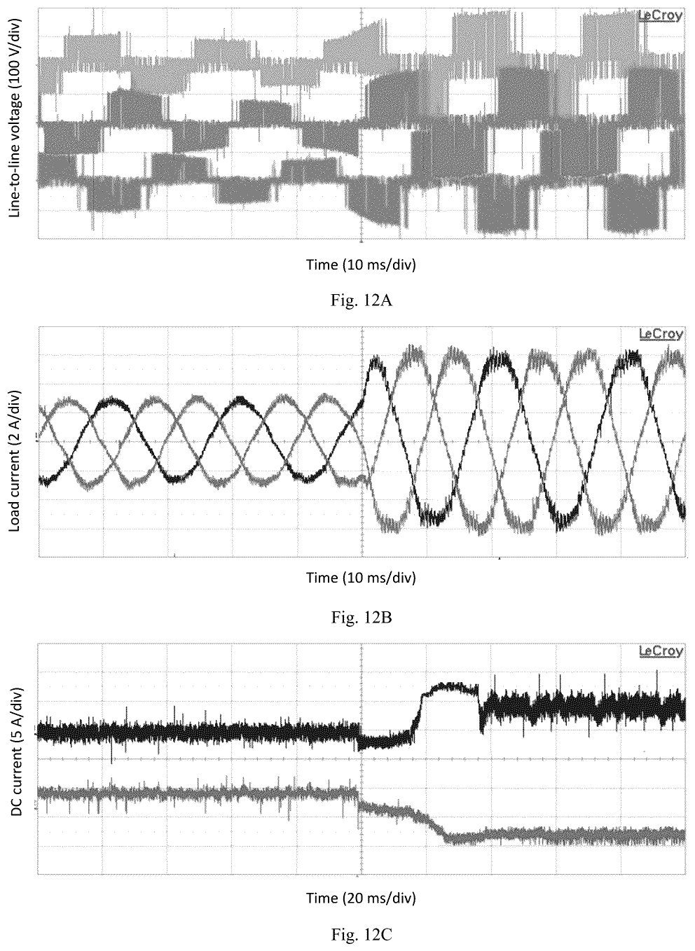

To show transient performance of the prototype embodiment, a step change from operating mode I to operating mode II was applied. The output line voltages, load currents, and DC currents are shown in FIGS. 12A-12C. Initially the MSI embodiment was operating in mode I. The UC bank supplied the load with a current of 2.5 A. The converter was then switched to mode II. As can be seen in FIG. 12C (note the different time scale), in mode II, the DC source current and UC bank current were positive and negative, respectively. The DC source charged the UC bank with a current of about 4 A and supplied the load concurrently. The three-phase currents are shown in FIG. 12B, in which the peak current amplitude changed from 2.5 A to 5.5 A by the transition from mode I to mode II.

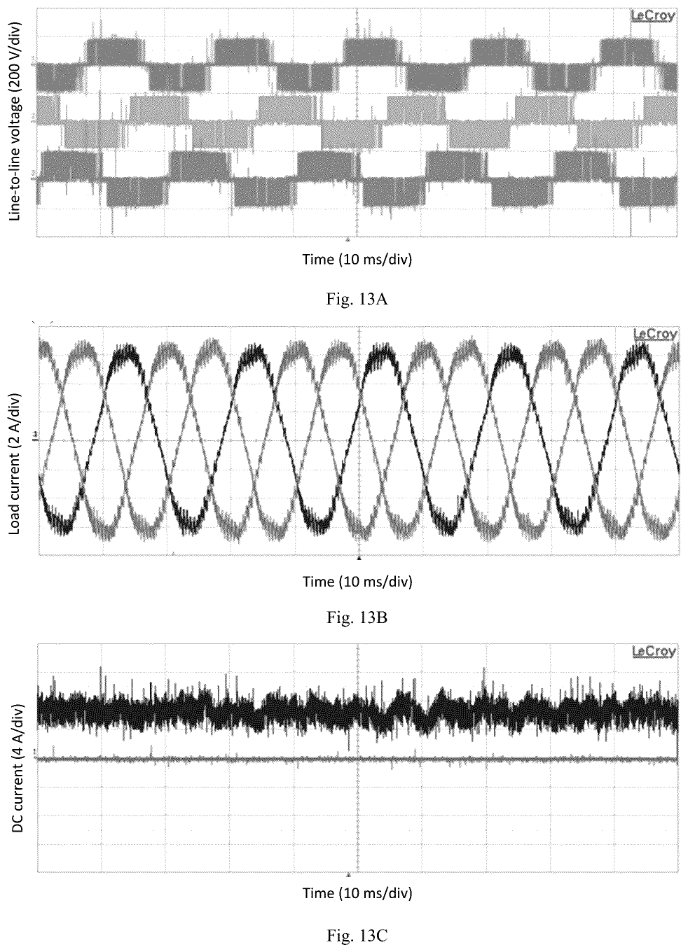

To show performance of the MSI embodiment operating in mode III, the reference current was increased to 4.5 A. The experimental results are shown in FIGS. 13A-13C. The DC link voltage of the voltage source inverter (VSI) had a voltage amplitude equal to the DC voltage source. Consequently, the line voltage waveform had a maximum amplitude equal to the DC voltage source (V_{DC1}), which was around 180 V. The DC source currents are shown in FIG. 13C. The DC source (upper trace) provided the load power, and the current of the UC bank (V_{DC2}, lower trace) was zero.

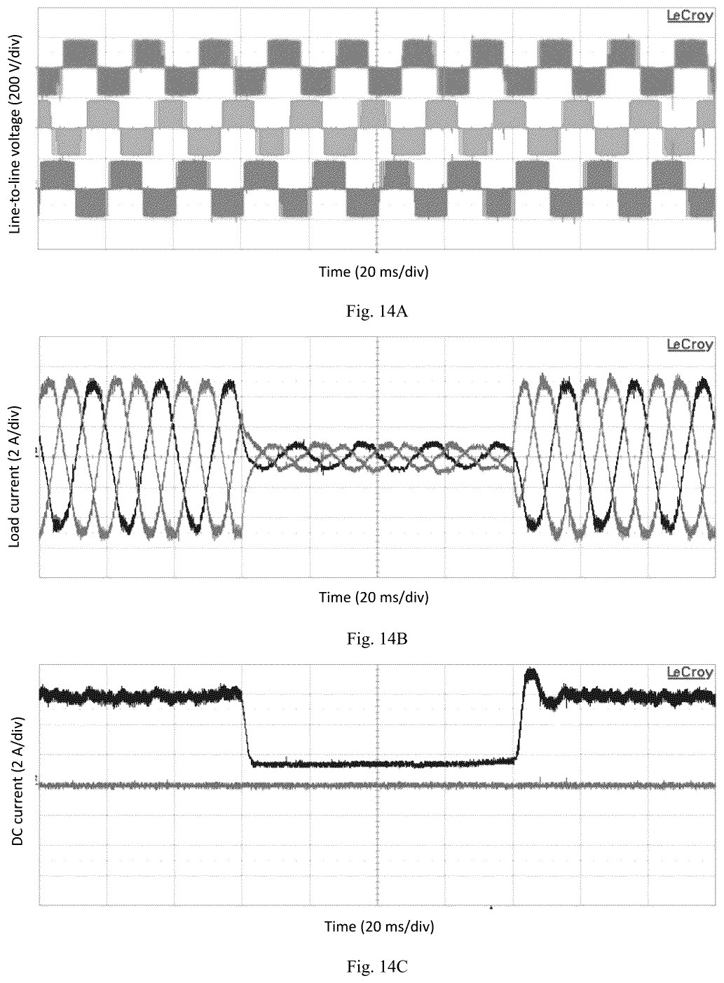

A step-change of 80 ms duration was implemented to test the performance of the MSI embodiment during a load transition from full load to 20% of full load. The output line voltages, load currents, and DC currents are shown in FIGS. 14A-14C. The MSI embodiment was operating in mode III. The DC source supplied a current of approximately 6 A to the load. The load current then decreased to one-fifth of its nominal value. The DC source current dropped to 1.5 A, and it supplied the load. When the load transition occurred, the peak AC current amplitude dropped from 5 A to 1 A, as shown in FIG. 14B. The converter returned to full load after 80 ms.

### EQUIVALENTS

It will be appreciated that modifications may be made to the embodiments described herein without departing from the scope of the invention. Accordingly, the invention should not be limited by the specific embodiments set forth, but should be given the broadest interpretation consistent with the teachings of the description as a whole.

### REFERENCES

[1] J. O. Estima and A. J. M. Cardoso, “Efficiency analysis of drive train topologies applied to electric/hybrid vehicles”, IEEE Trans. Veh. Technol., vol. 61, no. 3, pp. 1021-131, March 2012.
[2] A. Emadi and P. Magne, “Multi-source power converter”, U.S. Pat. No. 9,825,470, Nov. 21, 2017.
[3] L. Dorn-Gomba, P. Magne, B. Danen and A. Emadi, “On the Concept of the Multi-Source Inverter for Hybrid Electric Vehicle Powertrains”, IEEE Trans. Power Electron., vol. 33, no. 9, pp. 7376-7386, September 2018.
[4] Lea, Dorn-Gomba, “Multi-Source Inverter for Electrified Vehicles: Concept, Analytical Design, Efficiency Analysis, And Implementation”, PHD thesis, University of McMaster, Hamilton, Canada, 2018.
[5] L. Dorn-Gomba, E. Chemali and A. Emadi, “A novel hybrid energy storage system using the multi-source inverter”, 2018 IEEE Applied Power Electronics Conference and Exposition (APEC), San Antonio, TX, 2018, pp. 684-691.
[6] L. Dorn-Gomba, J. Guo and A. Emadi, “Multi-Source Inverter for Power-Split Hybrid Electric Powertrains”, IEEE Trans. Veh. Technol., vol. 68, no. 7, pp. 6481-6494, July 2019.

1. A modulation scheme for a three-phase multi-source inverter (MSI), comprising:
defining a stationary αβ plan of the three-phase voltages comprising six sectors I to VI, wherein each sector has seven existing space voltage vectors;
defining V_{ref} as a three-phase reference voltage vector in the αβ plan;
for each sector, calculating new space voltage vectors V_{M}, V_{S}, and V_{R} as linear combinations of at least two of the existing space voltage vectors;
dividing each sector into nine operating regions;
determining switching signals for switching devices of the MSI in each operating region in each sector using the V_{ref}, selected new space voltage vectors, and selected existing space voltage vectors.

2. The modulation scheme of claim 1, wherein the generating switching signals comprises using four selected existing space voltage vectors.

3. The modulation scheme of claim 2, wherein the four selected existing space voltage vectors include V₃-V₆.

4. The modulation scheme of claim 1, comprising:
calculating the new space voltage vectors for one sector selected from sectors I to VI;
determining corresponding new space voltage vectors in other sectors by interchanging the new space voltage vectors determined for the selected sector.

5. A non-transitory computer readable media compatible with a processor, the non-transitory computer readable media storing an algorithm that directs the processor to implement a space vector modulation (SVM) scheme for an MSI; wherein the SVM scheme comprises:
defining a stationary αβ plan of the three-phase voltages comprising six sectors I to VI, wherein each sector has seven existing space voltage vectors;
defining V_{ref} as a three-phase reference voltage vector in the αβ plan;
for each sector, calculating new space voltage vectors V_{M}, V_{S}, and V_{R} as linear combinations of at least two of the existing space voltage vectors;
dividing each sector into nine operating regions;
determining switching signals for switching devices of the MSI in each operating region in each sector using the V_{ref}, selected new space voltage vectors, and selected existing space voltage vectors.

6. A controller for a three-phase MSI, comprising:
a processor that executes an algorithm that implements the modulation scheme of claim 1; and
an output circuit that outputs the switching signals to switches of the MSI according to the modulation scheme.

7. The controller of claim 6, implemented in an electric vehicle.

8. A three-phase multi-source inverter (MSI) comprising the controller of claim 6.

9. A three-phase multi-source inverter (MSI), comprising:
a first switch having an input terminal adapted to receive a positive side of a first DC source (V_{DC1});
a second switch having an input terminal adapted to receive a negative side of the first DC source (V_{DC1}) and a negative side of a second DC source (V_{DC2});
an output of the first switch connected to inputs of third, fifth, seventh, and ninth switches;
the third switch having an output terminal adapted to receive a positive side of the second DC source (V_{DC2}) and connected to an input of a fourth switch;
outputs of the fifth, seventh, and ninth switches connected to inputs of sixth, eighth, and tenth switches and to output nodes corresponding to respective MSI three-phase output currents iₐ, i_{b}, and i_{c};
outputs of the second, fourth, sixth, eighth, and tenth switches connected together.

10. The three-phase MSI of claim 9, comprising at least one DC-DC converter that provides the first DC source or the second DC source.

11. The three-phase MSI of claim 9, wherein the first DC source comprises a high voltage source and the second DC source comprises a low voltage source.

12. The three-phase MSI of claim 9, wherein the first DC source comprises a high voltage source and the second DC source comprises a battery, a super capacitor, or an ultra capacitor.

13. The three-phase MSI of claim 9, configured for use in an electric vehicle.

14. The three-phase MSI of claim 9, comprising a controller.

15. The three-phase MSI of claim 14, wherein the controller controls switches of the MSI according to a space vector modulation (SVM) scheme.

16. The three-phase MSI of claim 15, wherein the SVM scheme comprises:
defining a stationary αβ plan of the three-phase voltages comprising six sectors I to VI, wherein each sector has seven existing space voltage vectors;
defining V_{ref} as a three-phase reference voltage vector in the αβ plan;
for each sector, calculating new space voltage vectors V_{M}, V_{S}, and V_{R} as linear combinations of at least two of the existing space voltage vectors;
dividing each sector into nine operating regions;
determining switching signals for switching devices of the MSI in each operating region in each sector using the V_{ref}, selected new space voltage vectors, and selected existing space voltage vectors.

17. The three-phase MSI of claim 16, configured for use in an electric vehicle.
